(19) United States
(12) Patent Application Publication
(10) Pub. No.: US 2022/0351116 A1
(43) Pub. Date: Nov. 3, 2022

(54) MONITORING ANOMALIES IN LOGISTICS NETWORKS

(71) Applicant: Siemens Aktiengesellschaft, Muenchen (DE)

(72) Inventors: Gerd Klevesaat, Konstanz (DE); Dominik Sacha, Ueberlingen (DE)

(21) Appl. No.: 17/765,864

(22) PCT Filed: Sep. 29, 2020
(86) PCT No.: PCT/EP2020/077171

§ 371 Date: Apr. 1, 2022

(30) Foreign Application Priority Data
Oct. 1, 2019 (EP) 19200838.1

(51) Int. Cl. G06Q 10/08

(52) U.S. Cl. CPC G06Q 10/083

(57) ABSTRACT

A method monitors a logistics network, in which mail items are processed at various network nodes and are transported on edges. The method includes: providing a computer-implemented data model, which describes aspects of the logistics network; transferring a stream of raw data of at least one subset of the network nodes, regarding mail items processed there, into the data model; processing, in an automated manner, secondary information obtained from the raw data, during operation, for the computer-assisted monitoring of anomalies in the logistics network, the raw data containing data sets, which each contain a time-related identification of a mail item at a network node; and obtaining the secondary information containing the performance of a comparison, in which a computer-implemented comparison function is applied to at least two of the time-related identifications.

The present invention relates to the technical field of the computer-assisted recognition and analysis of anomalies in logistics networks.

In logistics networks, mail items, for instance packages, pieces of baggage or letters or other general cargo, are processed at different nodes and transported on different edges. The acquisition and preparation of such data especially for the logistics domains offers the basis for decision-support logistics systems (monitoring & decision support). The time-dependent monitoring and analysis of such networks requires computer-assisted methods, which facilitate the network operators (domain experts and operators) with transparency relating to the current situation in the logistics network, and also with a historical analysis of normal behavior and anomalies. As a result, problems can be identified promptly and the need for action can be purposefully derived in good time.

An understanding, in other words knowledge, of the dynamic behavior of the network nodes and their relationship is developed on a long-term basis, said knowledge is firstly to be learned by the analysis system with the recurring occurrence of anomalies and is then to be applied in an automated manner.

The data is acquired from various data sources in the logistics network and prepared and merged in a complex manner for the logistics using a number of different data analysis processes and tools. The subsequent analysis of data and the modeling of normal behavior and anomalies is very time-consuming and requires expert knowledge, since the anomalies have to be recognized and evaluated. In the process the anomaly patterns are often concealed in the raw data and the large data set; a reduction in the data to the relevant information is therefore required. This often happens as a result of a manual inspection of the data, which is complex in respect of duration and scope and prone to error, by means of different standard tools, which do not continuously assist the process from the data acquisition through to the automatic recognition and use of anomaly information. Moreover, such standard tools are not adapted to specific requirements and properties of anomalies in the logistics.

Examples of such domain-specific anomalies can be found in the load behavior of the nodes at specific working times, circularly running mail items or mail items which violate the disclosure of SLA (Service Level Agreements). The anomalies are interpreted manually by the experts and the derived actions are often not returned to the system.

The object underlying the present invention is therefore to simplify the recognition and evaluation of anomalies and to render them less dependent on human experts.

This object is achieved by the solutions described in the independent claims. Advantageous embodiments are described in the dependent claims.

According to the invention, a computer-implemented method for the computer-assisted monitoring of a logistics network is presented. In the logistics network, mail items are processed at different network nodes and transported on edges. Here a computer-implemented data model is provided, which describes aspects of the logistics network. A stream of raw data from at least one subset of the network nodes by way of mail items processed there is transferred into the data model. Secondary information, obtained from the raw data, relating to the computer-assisted monitoring of anomalies in the logistics network is prepared automatically during ongoing operation. The raw data comprises data sets, each of which comprises a time-related identification of a mail item at a network node. The obtaining of secondary information comprises the performance of a comparison. Within the scope of the comparison, a computer-implemented comparison function is applied to at least two of the time-related identifications.

The comparison can be facilitated for instance on the basis of a derived state for a mail item or of the network. A derived state for a mail item is understood to mean, for instance, that the mail item was already identified at a number of nodes. A derived state of the logistical network is understood to mean, for instance, that a number of mail items was identified on one node at one time.

The preparation of the secondary information comprises for instance a representation and/or interpretation of a result of the comparison as to whether or not an anomaly exists in the logistics network. The preparation of the secondary information preferably also comprises an identification of one or more existing or potentially existing anomalies and their representation on an output device.

According to one exemplary embodiment, the logistics network is configured so that mail items are sent from a plurality of senders addressed to a plurality of recipients.

According to one exemplary embodiment, within the scope of the comparison, it is automatically determined in a computer-assisted manner that between two identifications, which differ in terms of time, of a mail item at a first network node, this mail item is identified at a second network node which differs from the first network. One such item of secondary information can be prepared as the existence of an anomaly. For instance, this comparison result can be prepared as an indication that the mail item is a circularly running item. Alternatively, the comparison result can also be assessed as an indication of the plurality of possible anomalies. For instance, there may be a circularly running item, but also a multiple assignment of a mail item identification.

According to one exemplary embodiment, within the scope of the comparison, it is automatically determined in a computer-assisted manner that a time difference between two identical identifications at different network nodes fails to reach a threshold value. For instance, the threshold value can be defined so that transportation between the different network nodes is impossible or improbable. One such multiple identification at different network nodes is referred to as hypermove, because it seemingly indicates an unrealistically fast transportation of the mail item, but is in actual fact instead an indication of an anomaly.

In this case there is an indication of a multiple assignment of a mail item identification. This exemplary embodiment can be combined independently of or in combination with the afore-described computer-assisted automatic determination, that between two identifications, which differ in terms of time, of a mail item at a first network node, this mail item is identified at a second network node which differs from the first network node.

According to one exemplary embodiment, the threshold value depends on a distance between the different network nodes. Therefore, the threshold value can be fixed or determined suitably for a plausible minimal time range or the earliest possible arrival time in the destination network node.

According to one exemplary embodiment, the logistics network and the data model are of the type that, in an anomaly-free operation of the logistics network, a mail item in the data model is displayed as clearly distinguishable from any other mail item. In other words, provided there is no anomaly, each mail item can be distinguished from any other mail item at a given time. This can be achieved, for instance, by each mail item being assigned a different code and being applied to the mail item in the form of a machine-readable code, for instance. Naturally, this does not mean that each anomaly would revert back to an ambiguity or multiple assignment of mail item identification codes. With circularly running items, this need not be the case, for instance.

According to one exemplary embodiment, the stream of raw data is enriched in a rule-based manner by the secondary information.

According to one exemplary embodiment, the computer-assisted monitoring of anomalies comprises the computer-assisted recognition of different categories of anomalies.

According to one exemplary embodiment, the computer-assisted monitoring of anomalies comprises the localization of a cause of an anomaly and/or the recognition of a time-based anomaly.

According to one exemplary embodiment, the computer-assisted monitoring of anomalies comprises an evaluation of recognized anomalies in the logistics network and/or the recognition of dependencies of anomalies recognized in the logistics network.

According to one exemplary embodiment, the secondary information obtained from the raw data is prepared by means of a computer-implemented learning system and preferably also analyzed in order to recognize new and known anomaly patterns therein.

According to one exemplary embodiment, the learning system is configured to train the preparation of secondary information by means of human-machine feedback, for instance by means of annotating data. The annotation of data can involve the tagging and/or labeling. Here the learning system is trained to categorize anomalies to capture from anomalies and/or actions.

According to one exemplary embodiment, the secondary information is prepared by interactive visualizations combined with machine learning and scalable real-time data processing methods.

According to one exemplary embodiment, the interactive visualizations are used to train the learning system by means of a human expert.

According to one exemplary embodiment, the monitoring of anomalies comprises the recognition of a circularly running item and/or the recognition of an abnormal output of a node or an edge and/or the recognition of mail items which spend too long in the logistics network and/or the recognition of conflicting information relating to one of the mail items and/or the recognition of erroneously changing information relating to one of the mail items (for instance if the label was incorrectly read) and/or the recognition of a mail item which, according to the raw data, seemingly appears simultaneously at several locations or with an impossibly short time lag (for instance if a mail item ID was assigned to different mail items). Here a circularly running item is a mail item which is passed around a circle within the logistics network of at least two nodes or are also passed around a circle within a network node of node-internal system and without further intervention would therefore not be delivered or delivered with an unnecessary delay.

According to one exemplary embodiment, anomalies and/or dependencies which appear at the same time are recognized. In this way, interrelationships can be recognized and specifically approached on a larger scale.

According to one exemplary embodiment, one or more new still unknown anomalies are recognized in a computer-assisted manner and presented to an expert by means of an interface, preferably in order to train the learning system, to assess these one or more new still unknown anomalies. As a result, the learning system can be further improved and a high degree of automation can be achieved.

According to the invention, an analysis system is moreover presented, which comprises means which are configured and adapted to carry out the inventive method.

According to one exemplary embodiment, the learning analysis system is configured to explore and monitor anomalies in logistics networks.

According to the invention, an analysis system is moreover presented, which comprises a first interface, a second interface and a processing facility. The first interface is configured to receive raw data from a logistics network. The raw data comprises data sets, which each comprise a time-related identification of a mail item at one of the network nodes of the logistics network. The processing facility comprises a data model, which describes aspects of the logistics network. The processing facility is adapted, during operation of the logistics network, to generate secondary information relating to the computer-assisted monitoring of anomalies in the logistics network from the raw data, by a comparison being carried out, in the scope of which a computer-implemented comparison function is applied to at least two of the time-related identifications.

According to one exemplary embodiment, the analysis system comprises means which are configured and adapted to execute a method according to one of the method claims.

According to one exemplary embodiment, a learning system is implemented in the processing facility in order to generate the secondary information. For instance, a neural network which is adapted to train the recognition of anomalies is simulated on the analysis system to this end.

According to one exemplary embodiment, a trained system is implemented in the processing facility in order to generate the secondary information. For instance, in this process a computer-implemented code is executed on the processing facility, said code having been trained to recognize anomalies by means of a simulated neural network or other machine learning methods. This generally involves recognizing a temporary abnormal set of events (volumes) or anomalies (circularly running items) on specific nodes and edges.

According to one exemplary embodiment, within the scope of the comparison, it is automatically determined in a computer-assisted manner whether between two identifications, which differ in terms of time, of a mail item at a first network node, this mail item is identified at a second network node which differs from the first network node. This makes it possible to check whether a circularly running item exists as an anomaly.

According to one exemplary embodiment, within the scope of the comparison, it is automatically determined in a computer-assisted manner whether a time difference between two identical identifications at different network nodes does not reach a threshold value. This makes it possible to determine whether a hypermove exists as an anomaly.

According to one exemplary embodiment, the threshold value depends on a distance or a transportation time to be expected between the different network nodes.

According to one exemplary embodiment, the logistics network is configured to send mail items from a plurality of senders addressed to a plurality of recipients.

According to one exemplary embodiment, the logistics network and the data model are of the type that in an anomaly-free operation of the logistics network, a mail item in the data model is displayed as clearly distinguishable from any other mail item.

Embodiments of the invention are explained in greater detail below on the basis of the figures, for instance.

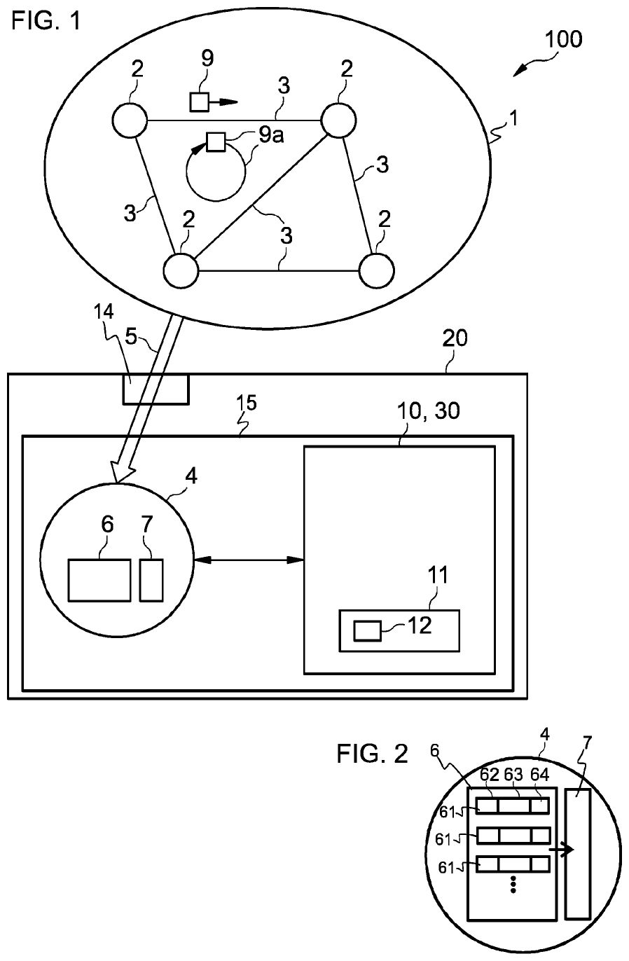

FIG. 1 shows a schematic block diagram for illustrating exemplary embodiments of the invention.

FIG. 2 shows a schematic representation of an exemplary embodiment of a data model;

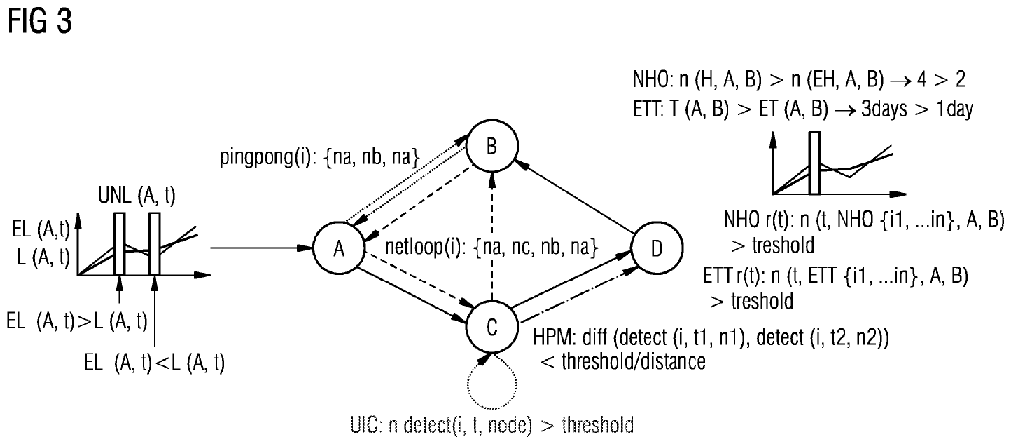

FIG. 3 shows a schematic representation of use cases for determining different types of anomalies.

FIG. 1 shows a logistical system 100, which comprises a logistics network 1, and an analysis system 20. The logistics network 1 is of the type that mail items are sent from a plurality of senders addressed to a plurality of recipients and comprises a number of network nodes 2, for instance distribution centers of one or more logistics senders and edges 3, which represent modes of transport of mail items 9 between the nodes 2. In an anomaly-free operation of the logistics network 2, each mail item is displayed in the data model in a clear manner which is distinguishable from any other mail item.

The analysis system 20 comprises a first interface 14, a data model 4, which describes at least some aspects of the logistics network 1, preferably the logistics network. The analysis system 20 moreover comprises a learning system 10, which simulates a neural network, for instance, and moreover comprises a second interface 11 (also referred to as interface 11). The data model 4 and the learning system 10 are included in a processing facility 15. In one variant of the invention, the analysis system 20 comprises an already trained system 30 instead of the learning system 10. In a further variant, the trained system 30 is simultaneously also a learning system.

In the logistics network 1, mail items 9 are processed at different network nodes 2 and transported on edges 3. The data model 4 is provided in order to monitor the logistics network 1 in a computer-assisted manner. The data model 4 describes aspects of the logistics network 1. A stream 5 of raw data 6 is routed from at least one subset of the network node 2 via mail items 9 processed there into the data model 4. In the system 20, secondary information 7 which is used for the computer-assisted monitoring of anomalies in the logistics network 1 and prepared during operation is obtained from the raw data 6. The obtaining of the secondary information comprises the performance of a comparison, in the scope of which a computer-implemented comparison function is applied to at least two of the time-related identifications.

The raw data 6 comprises, as the smallest raw data unit, an identification of a mail item 9 at a node 2. FIG. 2 shows a schematic, larger representation of the data model 4. The raw data 6 comprises data sets 61. Each data set comprises a mail item identification 63 of a mail item 9, a node identification 62 of that network node 2 at which the mail item 9 was identified, and a time stamp 62, which specifies when the mail item 9 was identified at the node 2.

The computer-assisted monitoring of anomalies comprises the computer-assisted recognition of different categories of anomalies and/or the localization of a cause of an anomaly and/or an evaluation of recognized anomalies in the logistics network 1 and/or the recognition of dependencies on anomalies recognized in the logistics network 1.

In turn, referring to FIG. 1, the secondary information 7 retrieved from the raw data 6 is prepared by means of a computer-implemented learning system 10.

The learning system 10 is configured to train the preparation of secondary information 7 by means of an interface 11 human-machine feedback, for instance by means of annotating data.

The preparation of the secondary information 7 is realized by interactive visualizations 12 combined with machine learning and scalable real-time data processing methods.

The interactive visualizations 12 are used to train the learning system 10 by means of a human expert.

The monitoring of anomalies includes the recognition of circularly running items 9a and/or the recognition of an abnormal output of a node 2 or an edge 3 and/or the recognition of mail items 9 which spend too long in the logistics network and/or the recognition of conflicting information relating to one of the mail items 9 and/or the recognition of erroneously changing information relating to one of the mail items 9 and/or the recognition of a mail item which, according to the raw data 6, seemingly appears simultaneously at a number of locations or with an impossibly short time lag.

In order to recognize a circularly running item, within the scope of the comparison, it is automatically determined in a computer-assisted manner whether between two identifications of a mail item 9, which differ in terms of time, at a first network node, this mail item is identified at a second network node which differs from the first network node.

A as hypermove is recognized, by, within the scope of the comparison, it automatically being determined in a computer-assisted manner that a time difference between two identical identifications at different network nodes fails to reach a threshold value. The threshold value depends on a distance or a transport time to be expected between the different network nodes.

Anomalies and/or dependencies between anomalies which occur at the same time are recognized by the analysis system 20.

One or more new still unknown anomalies are recognized in a computer-assisted manner by the analysis system 20 and presented to an expert by means of an interface 11, preferably in order to train the learning system 10 and in the process to assess these one or more new still unknown anomalies.

According to a further exemplary embodiment, a learning system for the analysis and monitoring of anomalies in the logistics networks is realized by a big data approach, which combines various methods for data processing, anomaly recognition and enrichment. This is based on a standardized domain data model, which is based on the smallest raw data unit—identification of a mail item at a node. With the data processing, the raw data stream is transferred into the data model and enriched there directly “on the fly” with information which is relevant especially to the logistics. According to further more detailed exemplary embodiments, different strategies are applied for the anomaly recognition:

1.) Rule-based on-the-fly enrichment by means of a real-time processing of the raw data and 2.) An analysis of time-dependent behavior by using machine learning methods. Here a distinction is also made between: a) deviations from learned normal behavior, b.) recurring deviations and c.) permanent changes in the network dynamics (deviation will become normal behavior). The data and recognized patterns are presented to the analysts by means of interactive visualization, said analysts facilitating an efficient analysis and evaluation of the patterns. On the one hand, the visualization elements are reduced to the relevant information, in order to counteract the cognitive overload. The data is shown in a map combined with other abstract visualization techniques, in order to be able to analyze data, anomalies and network properties from different perspectives (network, topology, time-dependent behavior, mail item streams). Recognized anomalies can be tagged by the experts and enriched with further information, such as for instance recommendations, or revised (with already acquired anomalies). The system 20 stores the enriched anomalies and uses this storage device continuously to automatically enrich new anomalies. In order to check and to efficiently annotate the learned historical data combined with new automatically enriched patterns, the anomalies and normal behavior are visualized in a cluster representation, wherein the recognized patterns can be annotated and corrected in summarized form (in various clusters). The interpretation of the recognized anomalies and their dependencies among each other are additionally analyzed and visualized automatically (Root Cause Analysis). Two strategies are followed here: 1.) The analysis of time dependencies with the occurrence of anomalies (time causality chain),

2.) Anomaly dependencies are analyzed and displayed along the network topology. Therefore different anomalies can be traced back to their origins at specific nodes (for instance if a problem in sorting center A has an impact (upstream and/or downstream) on other centers connecting the others).

According to further exemplary embodiments of the invention, based on a uniformly integrated solution adapted to the logistics, which facilitate the user with continuously monitoring and providing feedback. This is a learning system with human-machine feedback, which is realized by interactive visualizations combined with machine learning and scalable real-time data processing methods, wherein the analysis strategies are adjusted to the logistics domains. The solution offers an integrated user interface 11, as a result of which a combination of different techniques is made accessible to the domain experts and other users. These have the option of providing feedback (enrichment/annotation) so that the knowledge is acquired and is then used automatically by the system.

As a result, users without expert knowledge are also given access to the data in order to explore the data and anomalies transparently. This class of exemplary embodiments therefore renders the analysis of anomalies in dynamic networks more effective (better quality of the results), more efficient (quicker results, lower costs as a result of experts) and more accessible (different users along the entire analysis chain).

FIG. 3 shows a schematic representation of use cases for determining different types of anomalies. These can be classified as below:
Unbalanced Network Loads (UNL): Recognizing unbalanced loads, overloads and underloads.
   Reasons for this anomaly: Unexpected volumes are recognized in the logistical network. Reasons can be a reduced or excessively high mail item set on account of external influencing factors but also a temporary routing or failures of sorting nodes or transportations.
   Recognition of this anomaly: Known volume vs expected volume.
   Possible measures against the anomaly: The sets can be redistributed temporarily. Additional end points and transportation could be set up.
Needless Hops (NHO): Routing of mail items is not optimal—too many stations are recognized.
   Reasons for this anomaly: Problems occur with the processing of packages, either during the routing or during recognition (e.g. destination information) of the mail item. This is an unoptimized logistical network or operatively untreated fault situations.
   Recognition of this anomaly: Individual mail items requires longer mail item paths for longer than necessary. Paths can be analyzed according to length and number, temporary accumulation can infer transport mistakes or routing problem (e.g. temporary sorting plan changes).
   Possible measures against the anomaly: The set of mail items is monitored and processed manually. In the event of accumulations, the sorting plan and the logistical network is optimized.
Excessive Travel—Time (ETT): Mail items are underway for too long, SLA violation etc.
   Reasons for this anomaly: see NHO.
   Recognition of this anomaly: see NHO. Additionally, SLAs can be recognized on the basis of the travel time in the logistical network.
   Possible measures against the anomaly: See NHO. In the event of accumulations of SLA violations on specific routes, the network or the prioritization function can be adjusted.
Looping of Items (LOI): Identification and handling, mail items are identified recurrently at one node.
   Reasons for this anomaly: Problems occur with the recognition and routing of mail items, said problems resulting in circularly running items.
   Recognition of this anomaly: A distinction can be made between ping pong and network loop types. Returns are not permitted to be processed as faulty loops.
   Possible measures against the anomaly: Loops can be discharged and processed manually in order to avoid further transport mistakes.
Unexpected Inhouse—Cycling (UIC): Unexpected circles of mail items (contrary to the expected circuits, e.g. full east.)).
   Reasons for this anomaly: The package routing within the sorting center does not work, for instance, because the bar code is not read/interpreted correctly or it has detached itself from the mail item. The consequences can be LOI, Hyper moving (see below).
   Recognition of this anomaly: An excessive number of scans in a center is recognized.
   Possible measures against the anomaly: Follow-up without the relevant center.
Hyper moving (HPM): Mail items move too quickly, “jumps”.
   Reasons for this anomaly: Identifiers are used repeatedly, misreadings or the tracking mechanism is not clear.
   Recognition of this anomaly: The packages move more quickly in the logistical network than expected or possible.
   Possible measures against the anomaly: The reasons for repeated use, misreadings etc. can be attributed back to specific mail items (e.g. from a customer) or network elements and processed. For the recognition of other anomalies, HPMs can be ignored.

Further exemplary embodiments of the invention can comprise a recognition of the afore-described anomalies according to the following comparison functions (see FIG. 3):
Unbalanced Network Loads: UNL:
   L(N,t)!=EL(N,t)→The load L at a node N at time t does not equate to the expected load EL on the node N.
   For the anomaly recognition, the difference diff is examined on the basis of a threshold value threshold: diff(L(N,t), EL(N,t))>threshold.
   This can be realized from machine learning on the basis of different time frames and classifiers.
   Such a recognition of a temporary accumulation of UNLs can likewise be applied to UNLs and edges or other anomalies (LOI, UIC, etc.) on nodes, edges or paths in the network.
Needless Hops: NHO:
   For an individual mail item i on a route r: r(i): n(H,source,dest)>n(EH, source, dest)→more nodes n(H,source,dest) are located on the transmit path than expected n(EH,source,dest) between source (source) and destination (dest).
   For a set of mail items i1 . . . in on a route r at a time t, more NHOs than a threshold value threshold are recognized: r(t): n(t, NHO {i1, . . . in}, source, dest)>threshold)→A temporary deviation from the expected number of steps/hops on a route.
Excessive Travel Time: ETT.
   For a mail item on the route r the duration T is rougher than the expected duration ET: T(source, dest)>ET(source, dest).
   For a set of mail items i1, . . . in on a route r, more ETT mail items than a threshold value (expected set) are temporarily recognized at a time t. r(t): n(t, ETT, {i1, . . . in}, source, dest)>threshold.
Looping of Items: LOI:
   General Loop: on a path p(i): {na, nx, [ . . . ], na}→The mail item moves between nodes (na, nx) and is recognized repeatedly at the same node (na), but was recognized at another node in the meantime.
   Pingpong Loop for a mail item path pingpong(i): {na, nb, na}→general loop with just two nodes involved.
   Network Loop for a mail item path netloop(i): {na, nb, na}→general loop with more than two nodes involved.
Unexpected Inhouse Cycling: UIC
   n detect(i,t,node)>threshold→A mail item i is identified more often than its expected value threshold at a time t at a node.
Hyper Moving: HMP:
   diff (detect(i,t1,n1), detect(i,t2,n2))<threshold/distance→The time difference diff is smaller than an expected threshold value or the distance for the recognition of a mail item i between the nodes n1 and n2 at times t1 and t2.

On account of the previously described techniques, these anomalies can be acquired, characterized and stored. These stored anomalies can be further tagged/enriched for the learning system by the expert. The analysis of the derived data further comprises the dependencies of recognized anomalies:
Relations between anomalies:
   NPM, LOI, ETT etc.
      Long runtimes of loops vs long runtimes without loops
   Anomaly “cleaning”: e.g. HPM are not loops
   Filtering of individual anomaly classes results in further cases “of interest”
Pattern recognition:
   Derivation of anomaly features
   Time correlations
   Correlations between features and nodes/edges

The derived information (anomalies and patterns) can be used in combination with the stored information of the learning system for automatically generating recommendations and automatisms.

1-26. (canceled)

27. A computer-implemented method for computer-assisted monitoring of a logistics network, in which mail items are processed at various network nodes and transported on edges, the method comprises the steps of:
providing a computer-implemented data model describing aspects of the logistics network;
transferring a stream of raw data from at least one subset of the various network nodes via the mail items processed there into the computer-implemented data model;
automatically preparing secondary information obtained from the raw data during operation, for a computer-assisted monitoring of anomalies in the logistics network, the raw data containing data sets, each of the data sets having a time-related identification of a mail item at a network node of the various network nodes; and
obtaining the secondary information by performing a comparison, in a scope of which a computer-implemented comparison function is applied to at least two time-related identifications.

28. The method according to claim 27, wherein within a scope of the comparison it is automatically determined in a computer-assisted manner that between the at least two time-related identifications, which differ in terms of time, of a mail item at a first network node the mail item is identified at a second network node which differs from the first network.

29. The method according to claim 28, wherein within the scope of the comparison it is automatically determined in the computer-assisted manner that a time difference between two identical said time-related identifications at different ones of the various network nodes fails to reach a threshold value.

30. The method according to claim 29, wherein the threshold value depends on a distance or a transport time to be expected between different ones of the various network nodes.

31. The method according to claim 27, wherein the logistics network is of a type that the mail items are sent from a plurality of senders addressed to a plurality of recipients.

32. The method according to claim 27, wherein the logistics network and the computer-implemented data model are of a type that in an anomaly-free operation of the logistics network, the mail item in the computer-implemented data model is displayed as clearly distinguishable from any other ones of the mail items.

33. The method according to claim 27, wherein the computer-assisted monitoring of anomalies includes a computer-assisted recognition of different categories of anomalies.

34. The method according to claim 27, wherein the computer-assisted monitoring of anomalies involves a localization of a cause of an anomaly.

35. The method according to claim 27, wherein the computer-assisted monitoring of anomalies includes an evaluation of recognized anomalies in the logistics network and/or a recognition of dependencies on anomalies recognized in the logistics network.

36. The method according to claim 27, wherein the secondary information obtained from the raw data is prepared by means of a computer-implemented learning system.

37. The method according to claim 36, wherein the computer-implemented learning system is configured to train a preparation of the secondary information by means of an interface for human-machine feedback.

38. The method according to claim 37, wherein the preparation of the secondary information is realized by interactive visualizations combined with machine learning and scalable real-time data processing methods.

39. The method according to claim 38, which further comprises using the interactive visualizations to train the computer-implemented learning system by means of a human expert.

40. The method according to claim 27, wherein the computer-assisted monitoring of anomalies includes a recognition of a circularly running item and/or a recognition of an abnormal output of a node or the edge and/or a recognition of the mail items which spend too long in the logistics network and/or a recognition of conflicting information relating to one of the mail items and/or a recognition of erroneously changing information relating to one of the mail items and/or a recognition of a mail item which, according to the raw data, seemingly appears simultaneously at a number of locations or with an impossibly short time lag.

41. The method according to claim 27, wherein anomalies and/or dependencies between the anomalies, which occur at a same time, are recognized.

42. The method according to claim 27, wherein at least one new still unknown anomaly is recognized in a computer-assisted manner and presented to an expert by means of an interface.

43. The method according to claim 27, wherein the computer-assisted monitoring of anomalies includes a recognition of a time-based anomaly.

44. An analysis system, comprising:
a first interface configured to receive raw data from a logistics network, the raw data containing data sets, which each contain a time-related identification of a mail item on a network node of the logistics network;
a second interface; and
a processor implementing a data model describing aspects of the logistics network, said processor adapted, during operation of the logistics network, to generate secondary information, from the raw data, for a computer-assisted monitoring of anomalies in the logistics network, by a comparison being carried out, in a scope of which a computer-implemented comparison function is applied to at least two time-related identifications.

45. The analysis system according to claim 44, wherein said processor is configured and adapted to perform a computer-implemented method for a computer-assisted monitoring of the logistics network, in which the mail items are processed at various network nodes and transported on edges, said processor configured to:
provide the data model describing aspects of the logistics network;
transfer a stream of the raw data from at least one subset of the various network nodes via the mail items processed there into the data model; and
automatically prepare the secondary information obtained from the raw data during operation, for the computer-assisted monitoring of anomalies in the logistics network.

46. The analysis system according to claim 44, wherein said processor contains a trained system for generating the secondary information.

47. The analysis system according to claim 44, wherein said processor contains a learning system for generating the secondary information.

48. The analysis system according to claim 44, wherein within a scope of the comparison it is automatically determined in a computer-assisted manner whether between two of the time-related identifications, which differ in terms of time, of the mail item at a first network node the mail item is identified at a second network node which differs from the first network node.

49. The analysis system according to claim 44, wherein within a scope of the comparison, it is automatically determined in a computer-assisted manner whether a time difference between two identical ones of the time-related identifications at different network nodes does not reach a threshold value.

50. The analysis system according to claim 49, wherein the threshold value depends on a distance or a transport time to be expected between different ones of the network nodes.

51. The analysis system according to claim 44, wherein the logistics network is configured to send the mail items from a plurality of senders addressed to a plurality of recipients.

52. The analysis system according to claim 44, wherein the logistics network and the data model are of a type that in an anomaly-free operation of the logistics network, the mail item is displayed in the data model as clearly distinguishable from any other ones of the mail items.
